(19) United States
(12) Patent Application Publication
(10) Pub. No.: US 2009/0267303 A1
(43) Pub. Date: Oct. 29, 2009

(54) METHOD FOR CLOSING BAGS MADE OF PLASTICS AND CLAMPING CLIP FOR IMPLEMENTING THE METHOD

(75) Inventors: Detlef Nuppenau, Salem (DE); Dieter Schmidt, Hamburg (DE); Eugen Kruger, Schwarzenbek (DE); Michael Markl, Gresse (DE); Jens Mannshardt, Ratzeburg (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Fette GmbH, Schwarzenbek (DE)

(21) Appl. No.: 12/421,014

(22) Filed: Apr. 9, 2009

(30) Foreign Application Priority Data
Apr. 23, 2008 (DE) 10 2008 020 747.0

(51) Int. Cl. B65D 33/16; F16J 15/02

(52) U.S. Cl. 277/312; 24/30.5 R

(57) ABSTRACT

Method for closing bags made of plastics, in which initially a clip made of plastics is positioned in a clamping manner around the gathered upper end of the bag and subsequently the gathered end of the bag is welded and/or sealed by means of a hot surface.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Plastics bags are generally used for storing and transporting goods of all types. They are used, amongst other things, for receiving and transporting filter dust. In order to prevent the goods or individual particles from escaping, various possibilities are known for closing the bag. One possibility consists in sealing the open end with a clip. A further possibility consists in welding or sealing the upper ends by means of a hot surface. A drawback with both methods is that often the slightest leakages occur or the closure opens as a result of mechanical stress. With plastics bags which contain toxic material, this has to be avoided at all costs.

The object of the invention, therefore, is to provide a method for closing bags made of plastics, by which it is ensured that the bag is tightly closed and no particles may escape.

### BRIEF SUMMARY OF THE INVENTION

In the method according to the invention, initially a clip made of plastics is positioned in a clamping manner around the gathered upper end of the bag. Subsequently, the gathered end of the bag is welded or sealed by means of a hot surface. The sealed surface ensures that no particles may escape from the bag.

The method according to the invention is particularly advantageous if, at the same time as positioning the clip around the gathered end of the bag, which may be carried out in the known manner by a tool, the tool is simultaneously designed to carry out the sealing by means of a hot surface.

In a further variant, the method according to the invention provides that, after closing the bag, the plastics clip is cut transversely into two adjacent clip portions and the end of the bag produced by the separating cut is welded and/or sealed by means of the hot surface. Preferably, the sealing, together with the separating cut, are carried out by means of a hot cutting tool.

The cutting tool may, for example, be cutting shears.

A plastics clip for carrying out the method according to the invention has a one-piece clip body, which contains two adjacent clip portions, of which each may be positioned in a clamping manner around the gathered end of the plastics bag. The clip portions are connected via a separating web which may be cut through transversely by a cutting tool.

In a further embodiment of the invention, it is further provided that each clip portion has an approximately C-shaped clamping clip, on the one end thereof a jaw being formed and a pull tab being connected to the clamping clip, which may be inserted with the free end into the jaw, the jaw and the pull tab comprising retaining means. Such retaining means are, for example, known in connection with so-called cable ties.

In an alternative, a further embodiment of the invention provides a double clip, in which each clip portion has a C-shaped clamping clip, on the outside of the C-shaped clamping clip a jaw being formed with internal locking means and on the opposing side of the clamping clip an elongate projection being formed, which may be inserted into the jaw when the clamping clip is pressed together and cooperates in a locking manner with the locking means of the jaw. The locking may, for example, be formed by corresponding teeth on the projection and in the jaw. It is understood that the clamping clip is correspondingly resilient, in order to facilitate the passing of the clamping clip round the end of a bag and simultaneously the pressing together of the clamping clip around the gathered end portion of the bag and at the same time the locking of the jaw and projection. Also, such a clip may be formed in a simple manner in two parts with an intermediate web, which allows subsequent cutting.

### BRIEF DESCRIPTION OF EACH OF THE FIGURES OF THE DRAWINGS

An embodiment of a clip according to the invention is explained in more detail hereinafter with reference to drawings, in which:

FIG. 1 shows the side view of a clip according to the invention,

FIG. 2 shows the view of the clip according to FIG. 1 in the direction of the arrow 2,

FIG. 3 shows a side view of a further embodiment of a clip according to the invention,

FIG. 4 shows in perspective the rear face of the clip according to FIG. 3.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

A clip shown in FIG. 1 has a clip body 12 with a clamping clip 14 which is of approximately C-shaped configuration. In the region of one end of the clamping clip 14 a jaw 16 may be seen. Approximately centrally on the rear face of the clamping clip 14 a pull tab 18 is attached. The pull tab may be inserted with its free end into the jaw 16, in order to clamp an object located therebetween.

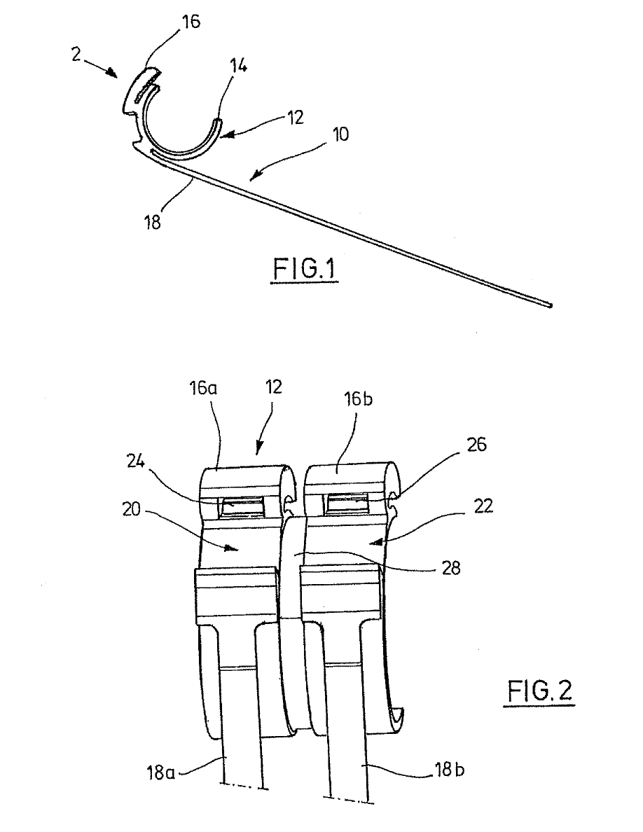

In FIG. 2 the clip body is shown in perspective and may be seen more clearly. It has a first clip portion 20 and a second clip portion 22. Each portion 20, 22 has a jaw 16a, 16b with a through-opening 24 and/or 26. One respective pull tab 18a, 18b is connected to the portions 20, 22. Between the clip portions 20, 22 a relatively thin circular web 28 is provided which connects the two portions 20, 22 together.

During use, the clip body 12 is positioned around the upper gathered end of the plastics bag, not shown, and the two clip portions 20, 22 are pressed together in a clamping manner, by the pull tabs 18a, 18b being passed through the jaw 16a, 16b. In the through-openings 24, 26, catches, tongues or similar latching means are provided which cooperate in a latching manner with the pull tab 18a, 18b which is, for example, toothed, in order to prevent the pull tab 18a, 18b from being pulled out. Such a principle is known, for example, in cable ties.

After a closure has been carried out in the disclosed manner, cutting of the two clip portions 20, 22 is undertaken by means of a cutting tool, for example cutting shears, by the connecting web 28 being cut through transversely to the axis of the clip portions 20, 22 and the bag. The cutting shears may at the same time be heated so that, when cutting, the opposing ends of the plastics bag, which are also cut through, are welded or sealed. In this manner, the plastics bag is securely closed, without at any time particles from its interior being able to reach the surroundings.

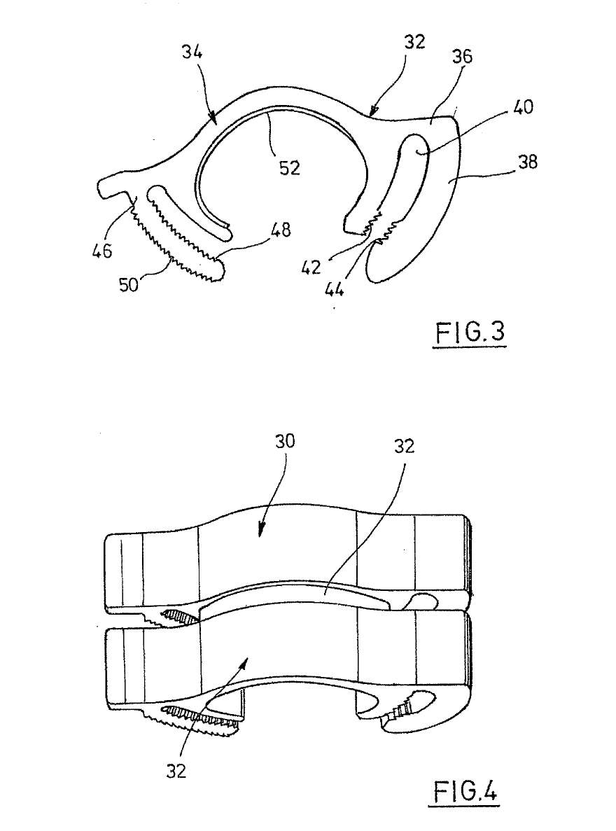

In FIG. 4 a double clip is shown with a first clip portion 30 and a second clip portion 32, which are connected to one another by a connecting web 32. The double clip according to FIG. 4 is also made in one piece from plastics material. In FIG. 3, the clip portion 32 is reproduced according to FIG. 1. A C-shaped clamping clip 34 is visible, on the outside thereof at 36 an external clip portion 38 being formed which extends approximately parallel to the associated portion of the clamping clip 34. As a result, a jaw 40 is formed which has a toothing 42 and/or 44 on opposing sides at the opening.

On the outside of the opposing leg of the C-shaped clip 34, a further projection 46 is formed which also extends approximately parallel to the associated leg and which has a toothing on opposing sides at 48 and 50. The toothings 42, 44 and/or 46, 48 are saw-tooth shaped.

In FIGS. 3 and 4, the double clip is shown in the relaxed state. During use, the clamping clips 34 are positioned around a gathered end of a plastics bag, not shown. Subsequently, the legs are pressed together, whereby the projection 46 penetrates the jaw 40. The toothings 42, 44, 46, 48 cooperate and thereby lock the projection 46 in the jaw 40. Unlocking is only possible by the clip being cut or the portions forming the jaw 40 being moved sufficiently far apart from one another that the projection 46 may be pulled out.

As also set forth in the above embodiment, both portions of the clip are positioned around the gathered end of the plastics bag. Subsequently, a cut is made in the region of the web 32 by means of cutting shears or the like, whereby at the same time the cut ends of the plastics bag are welded or sealed. As a result, the plastics bag is securely closed.

In FIG. 3 it may be seen that a web 52 extends over the internal periphery of the C-shaped clamping clip 34. Preferably, each of the C-shaped clamping clips 34 have two spaced-apart webs. Said webs are used for improved sealing of the end of the plastics bag when both clamping clips are positioned around said bag. Moreover, they prevent the clip from being pulled off the bag.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. Method for closing bags made of plastics, in which initially a clip made of plastics is positioned in a clamping manner around the gathered upper end of the bag and subsequently the gathered end of the bag is welded and/or sealed by means of a hot surface.

2. Method according to claim 1, characterised in that after closing the bag, the plastics clip is cut transversely into two adjacent clip portions and the end of the bag produced by the separating cut is welded and/or sealed by the hot surface.

3. Method according to claim 2, characterised in that the sealing, together with the separating cut, are carried out by means of a hot cutting tool.

4. Plastics clip for carrying out the method according to claim 1, characterised in that a one-piece clip body (10) has two adjacent clip portions (20, 22), of which each may be positioned in a clamping manner around the gathered end of the plastics bag, and the clip portions (20, 22) are connected to one another via a separating web (28) which may be cut through transversely by a cutting tool.

5. Plastics clip according to claim 4, characterised in that each clip portion (20, 22) has an approximately C-shaped clamping clip (14), on the one end of the clamping clip a jaw (16a, 16b) being formed and a pull tab (18) being connected to the clamping clip (14), which may be inserted with the free end into the jaw (16a, 16b), the jaw and the pull tab comprising cooperating retaining means.

6. Plastics clip according to claim 4, characterised in that each clip portion (30, 32) has a C-shaped clamping clip (34), on the outside of the C-shaped clamping clip a jaw (40) being formed with locking means and on the opposing side of the clamping clip (34) an elongate projection (46) being formed, which may be inserted into the jaw (40) when the legs of the clamping clip (34) are pressed together and the projection cooperates in a locking manner with the locking means of the jaw.

7. Plastics clip according to claim 6, characterised in that the jaw (40) and the elongate projection (46) have at least one respective toothing (42, 44, 46, 48).

8. Plastics clip according to claim 7, characterised in that a toothing (42, 44, 46, 48) is formed on each side of the projection (46) and the jaw (40).

9. Plastics clip according to claim 4, characterised in that on the inside of the C-shaped clamping clip (34) at least one web (52) is provided extending over one part of the internal periphery of the clamping clip (34).
